(19) United States
(12) Patent Application Publication
(10) Pub. No.: US 2010/0082560 A1
(43) Pub. Date: Apr. 1, 2010

(54) SOFTWARE CHANGE MANAGEMENT, CONFIGURATION SUBSTITUTION AND REMOTE ADMINISTRATION OF DATACENTERS

(75) Inventors: Nathan George Wiger, San Diego, CA (US); Matthew David Miller, San Diego, CA (US); Ronald Earl Andres, Chula Vista, CA (US)

Correspondence Address: JOSHUA D. ISENBERG;JDI PATENT, 809 CORPORATE WAY, FREMONT, CA, 94539, US

(73) Assignee: Sony Computer Entertainment America Inc., Foster City, CA (US)

(21) Appl. No.: 12/234,510

(22) Filed: Sep. 19, 2008

(51) Int. Cl. G06F 17/30; G06F 15/177; G06F 15/16

(52) U.S. Cl. 707/695; 709/221; 707/E17.005; 707/E17.032; 707/E17.045

(57) ABSTRACT

Change management in a relational database may be implemented by indexing changes by copying the database to a new revision when a change is made to one or more items in the database. The new revision may be committed as a single unit and all changes stored together under a single revision. Database users may be notified of the new revision that is available for use. Software configuration issues may be simplified through the use of a configuration language that separates the logical configuration between software components from the specific configuration of those components. Secure data center administration may be handled through the use of control hosts.

### FIELD OF THE INVENTION

This invention is related to software development and more particularly to methods and systems for dealing with change management, separation of logical software configuration from specific configuration, and secure datacenter administration.

### BACKGROUND OF THE INVENTION

A computer database is a structured collection of data that is stored in a computer system. A database relies upon software to organize the storage of data. One common type of database is known as a relational database. A relational database is a database that conforms to the relational model, which refers to a database's data and structure by which the data are arranged. The term “Relational database management system” (RDBMS) is often used to refer to software used to create a relational database. A relational database may be thought of as a collection of relations. A relation is commonly defined as a set of tuples (sequences or ordered lists of values) that all have the same attributes. This is often represented by a table organized into rows and columns. In a relational database, all the data stored in a column are said to be in the same domain. This means that values stored in a single column are all of the same data type and conform to the same constraints.

A common challenge associated with databases is change management, which refers to how a RDBMS handles changes to data stored in the database. This is often a concern when multiple users remotely access a common database. A number of prior art systems have been developed that can perform change management. However, a primary shortcoming of such systems is that they do not store changes in a single, coherent image. Instead, a change is usually given a unique ID, and then publishing those changes involves referencing every ID of every change to reconstruct a coherent image.

Additional problems are associated with databases that are used in development of software. In particular, software is often configured by entering specific values for a set of parameters. For example, on a home router, one might set the “IP address” to 127.0.0.1, or the “DHCP Expiration” to 10 days. On small scales, this works relatively well. However, if it is desired to setup additional routers on a network, all of the settings must be manually entered for each new router.

Other problems arise from issues related to administration of remote datacenters. Often multiple datacenters are connected to each other via a network. One problem that arises is how to securely administer remote datacenters, without being granted access to that datacenter's network. Normally, a system administrator (sysadmin) will setup one or more central servers that have access to all the hosts on the network. This eases administration, since the sysadmin can login to a single system and control. However, this requires that the sysadmin own and/or control all hosts on that network.

It is within this context that embodiments of the invention arise.

### BRIEF DESCRIPTION OF THE DRAWINGS

The teachings of the present invention can be readily understood by considering the following detailed description in conjunction with the accompanying drawings, in which:

FIG. 1 is a block diagram illustrating an example of change management according to a first embodiment of the present invention.

FIG. 2 is a flow diagram illustrating according to an embodiment of the present invention.

FIG. 3A is an illustration of simplifying software configuration issues according to a second embodiment of the present invention.

FIG. 3B is a detailed illustration of an example of a logical configuration according to a second embodiment of the present invention.

FIG. 4 is an illustration of handling secure data center administration through the use of control hosts according to a third embodiment of the present invention.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

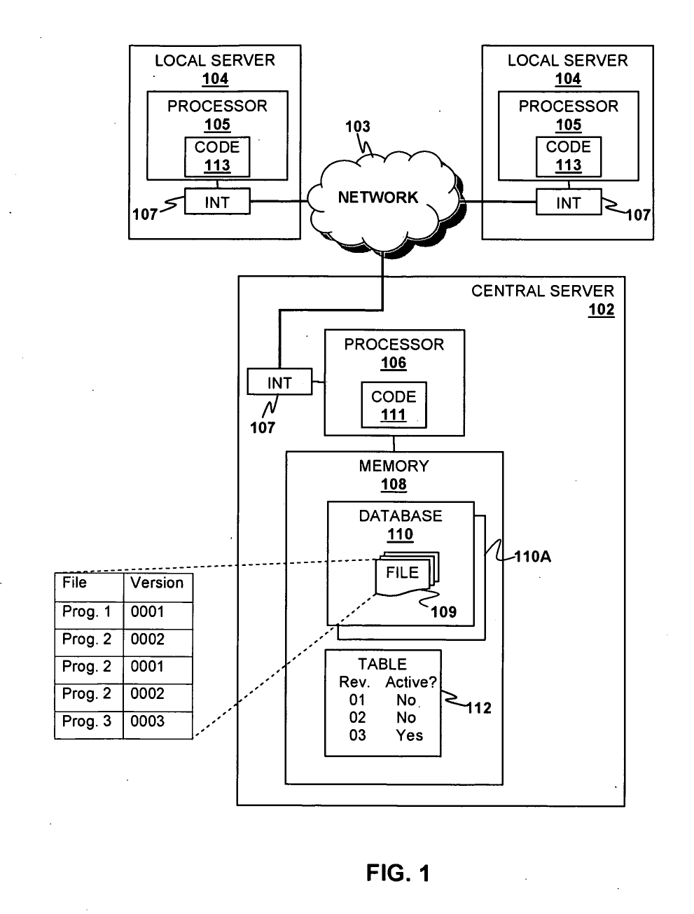

Embodiments of the present invention are related to relational databases. According to first embodiment, a change management system may index changes by way of revisions stored in a relational database. The block diagram of FIG. 1 depicts an example of how such a system may be implemented. Specifically, a central server 102 and one or more local servers 104 may be coupled to each other over a network 103. Each local server 104 may include a processor 105 coupled to a network interface 107. The central server 102 may include a processor 106 and an associated memory 108. The central server 102 may also include a network interface 107 to facilitate communication over the network 103.

The processor 106 of the central server 102 may include one or more processing cores. By way of example and without limitation, the processor 106 may be a parallel processor module, such as a Cell Processor. The memory 108 may be operably coupled to the processor 106 by any suitable means, such as a data bus. In some implementations the memory and processor are components of a common device, such as a general-purpose computer. In other implementations, the processor and memory may be separate devices that are remotely located with respect to each other. The memory 108 may be in the form of an integrated circuit (e.g., RAM, DRAM, ROM, and the like). Alternatively, the memory 108 may provide non-volatile storage for code and data. By way of example, such non-volatile storage may be implemented in the form of a fixed disk drive, removable disk drive, flash memory device, tape drive, CD-ROM, DVD-ROM, Blu-ray, HD-DVD, UMD, or other optical storage devices.

A database 110 may be stored in the memory 108. The database 110 may generally include several data entries which may be organized in terms of records and fields. Each record may represent a grouping of related fields. Each field may represent a different file 109 containing data of a common type. Different files 109 may be distinguished by identifying information which may be in the form of metadata embedded in a file header. By way of example, and without loss of generality, the database 110 may be used with an ANSI compliant RDBMS, such as Oracle, MySQL, Sybase, PostgreSQL, etc. Fields in the database may contain any type of data. In a preferred embodiment, the database 110 is a software database and each field may correspond to a file 109 containing a different software program.

In accordance with the first embodiment, when an operator initiates making a change to the database 110, a complete “snapshot” is made of the existing data, by way of copying the entire database to a new revision 110A. The new revision 110A may contain any number of arbitrary changes to any number of data elements stored in the database. When the operator is done making changes, the new revision 110A is committed as a single unit. This means that all changes are stored together under a single revision. This allows publishing any changes by simply indicating which revision of the database should be used. To facilitate publishing of revisions, the memory 108 may also contain a table 112 containing information identifying different revisions of the database 110 and information indicating whether a given revision is active or not.

The process of publishing a revision amounts to simply marking it as “active.” There are several key advantages to this approach. First, a revision is completely self-contained, meaning that its integrity is guaranteed. Second, publication is nearly instantaneous, since only one record needs to be changed. Third, all publication methods are equally simple. Normally, change management systems are designed to handle standard publications, but operations such as “rollbacks” (where changes are reverted to their previous state) are difficult. In the first embodiment of the invention, by contrast, all publication methods involve just changing the active revision.

As discussed above, other change management systems exist, but they typically use individual change ID's for each different change made to the database during the course of a given revision. Such systems may have been developed this way because they appear (on the surface) to be easier to develop. Although a revision system according to this embodiment may be relatively complex to implement, upkeep of such a system is much simpler, since higher-level pieces of an application that uses the database 110 do not have to track individual changes.

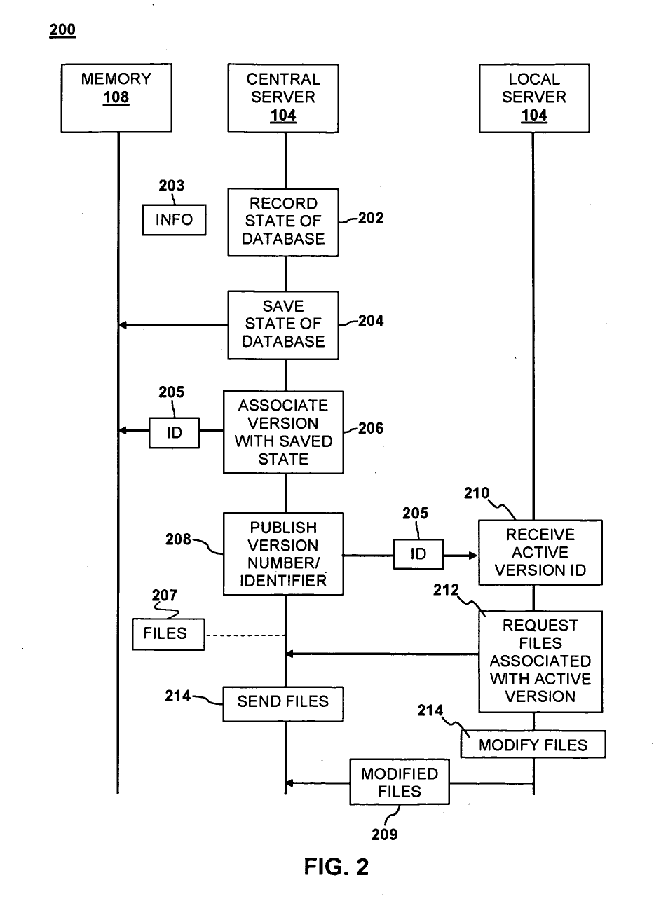

A method 200 for change management in accordance with the first embodiment may be understood by referring simultaneously to the block diagram of FIG. 1 and the flow diagram depicted in FIG. 2 illustrates an example of a method for change management 200. It is noted that the method 200 may be implemented by execution of appropriately configured software instructions 111 on the central server 102 or similarly configured instructions 113 on one or more of the local servers 104. Specifically, as indicated at 202, information 203 representing a state of data in the database 110 at a particular instant of time may be recorded. The information 203 may include all of the data stored in the database 110 at that instant of time, as indicated at 204. By way of example, the information 203 may be saved as a revision in the main memory 108 associated with the central server 102. A revision identifier may be associated with the state of the database 110 at the particular instant in time as indicated at 206. By way of example, a revision number or other identifier may be stored in the table 112. Revision information 205, e.g., the revision number or other identifier may then be published to one or more of the local servers 104 as indicated at 208. The revision information 205 identifies which revision stored in the database 110 is the active revision. Since all revisions to the data in the database 110 are stored with each revision of the database, it is relatively easy to revert to a previous revision, if necessary. Specifically, the database may revert to a previously saved revision by publishing revision information 205 that identifies the previously saved revision as the active revision to the local servers 104.

Changes to the database 110 may be handled by a local server 104 as follows. The local server 104 receives revision information 205 that identifies the active revision of the data in the database 110 as indicated at 210. When access to the database 110 is desired the local server 104 may request one or more data items 207 associated with the active revision from the central server 102 as indicated at 212. The central server 102 may then send the requested data to the local server 104 as indicated at 214. The data may then be used by the local server 104. In addition, the central server 102 may execute instructions that carry out the sequence of events described above and indicated at 202, 204, 206 and 208 thereby making a new revision of the database 110 containing the modified data 209 of the active revision.

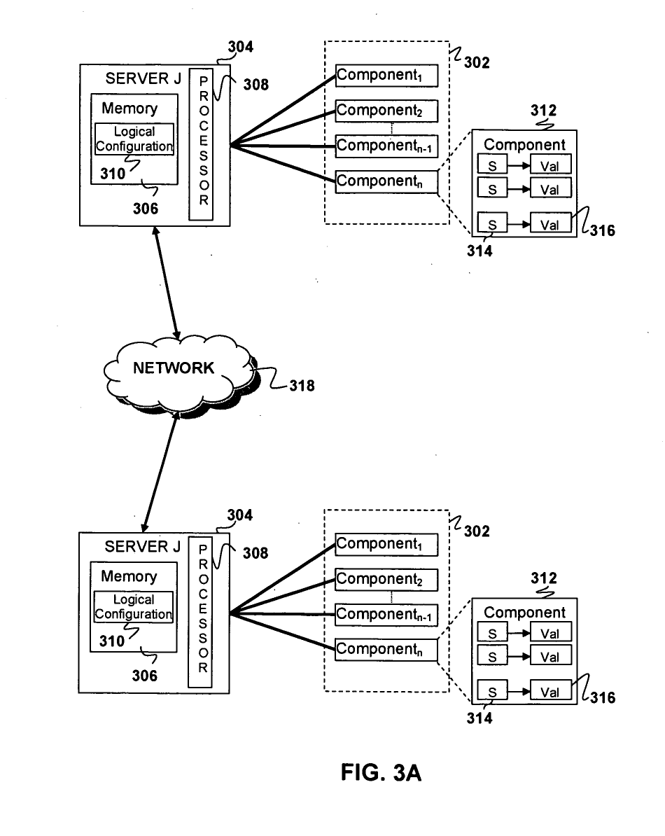

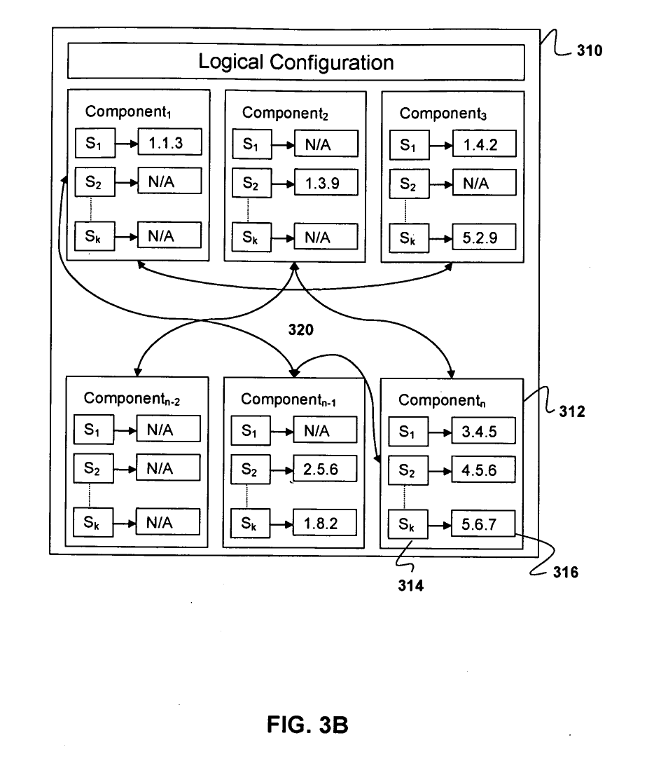

According to a second embodiment illustrated in FIGS. 3A-3B, software configuration issues may be simplified through the use of a configuration language that separates the logical configuration 310 between software components 312 from the specific configuration 302 of those components 312 as illustrated in FIG. 3A. A specific configuration 302 consists of defining all of the relationships between the components 312 of the configuration as well as defining a value 316 for each setting 314 of each component 312. A logical configuration 310 on the other hand may define only certain relationships between components 312 and certain values 316 of certain settings 314, leaving the rest of the definitions for the settings 314 to be resolved automatically by the system. The benefits of the logical configuration 310 lie in its ability to act as a skeleton or framework for other specific configurations 302. Certain relationships and setting values 316 hold constant for each specific configuration 302, and thus by allowing the logical configuration 310 to act as a framework for each specific configuration 302, the amount of repetition involved in defining these constant relationships and constant setting values may be reduced.

By way of example, and not by way of limitation, a specific configuration 302 may be configured through the use of a server 304 coupled to the components 312 of the configuration. These components 312 may each include several different settings s₁ . . . sₖ 314, each defined by a certain value 316. The server 304 may include a processor 308 that operates to communicate information between the different components 312 and the server 304. The processor 308 may include one or more processing cores. By way of example and without limitation, the processor 308 may be a parallel processor module, such as a cell processor. The server 304 may also consist of a memory 306 associated with storing information for the processor 308 to later use. The memory 306 may be operably coupled to the processor 308 by any suitable means, such as a data bus. In some implementations, the memory 306 and processor 308 are components of a common device; in other implementations the memory 306 and processor 308 may be separate devices that are remotely located with respect to each other. The memory 306 may be in the form of an integrated circuit (e.g., RAM, DRAM, ROM, and the like). Alternatively, the memory 306 may provide non-volatile storage in the form of a fixed disk drive, removable disk drive, flash memory device, tape drive, CD-ROM, DVD-ROM, Blu-Ray, HD-DVD, UMD, or other optical storage device.

The memory 306 stores the logical configuration 310, which acts as a skeleton for the specific configuration 302. The logical configuration 310 may define certain relationships between components 312 and may also define certain values 316 of certain settings 314. In addition to the relationships and setting values 316 defined by the logical configuration 310, the user may further define certain setting values 316 for a specific configuration 302 by referencing setting values 316 of other configurations. The format for this substitution syntax may be of the form: $[<component>.<optional sub-component>.<setting>].

By way of example, and not by way of limitation, a component might be a piece of software, hardware, or data itself. For example, a component may be a router. On the component, an optional sub-component may be a module or sub-category which contains a logical set of functionality. On a router, a sub-component may be the wide-area network (WAN) module. Within the optional sub-component, a setting would provide a means to access the configuration for that logical element. On a router, within the WAN module, a setting may be the IP address. In this example, the setting may look like $[router.wan.ip]. By way of an additional example, on a router with DHCP support, enabling that DHCP support might be by way of a variable named $[router.dhcp.enable]. These settings could be used within the change management system to both set and query these configuration values.

For example to reference a database username, one may use: $[database.username]. A user may also define relationships between components for a specific configuration 302. For example, the syntax component2.client.IP=$[component1.server.IP] may be used to express that component 2's “client IP” connects to component 1's “server IP”. Additionally, multiple setting values may be concatenated together, e.g., with “+”. For example the syntax component2.url=http://+$[component1.server.hostname]+“:”+$[component1.server.port]+$[component1.server.url] may be used to express that component2's url may be obtained by concatenating http:// with component 1's server hostname, server port and server url.

Furthermore, default values may be included e.g., by using the “or” keyword. For example the syntax component2.server.port=$[component1.server.port] or 10075 may be used to set the set the server port for component2 to the server port for component1 if that server port is defined or to 10075 if not.

Each specific configuration 302 embodied through the use of a server 304 may be connected to a network 318 which can communicate information between separate specific configurations 302. The network 318 allows for a user to use the substitution syntax and concatenation syntax described above for specific configurations 302 to reference setting values 316 from each other. The network 318 may also serve to allow servers 304 to access logical configurations 310 of other servers 304.

FIG. 3B illustrates an example of a logical configuration 310 according to an embodiment of the present invention. The logical configuration 310 acts as a map for other specific configurations 302 to define certain relationships 320 between components 312 and to define certain setting values 316. Certain relationships 320 and certain setting values 316 are left undefined, such that the user can input data to define these relationships and setting values 316. By using the logical configuration 310 as a skeleton for the specific configuration 302, it is possible to reduce the amount of repetition necessary to define such relationships 320 and such setting values 316. This in turn can reduce the amount of error associated with defining relationships and setting values 316.

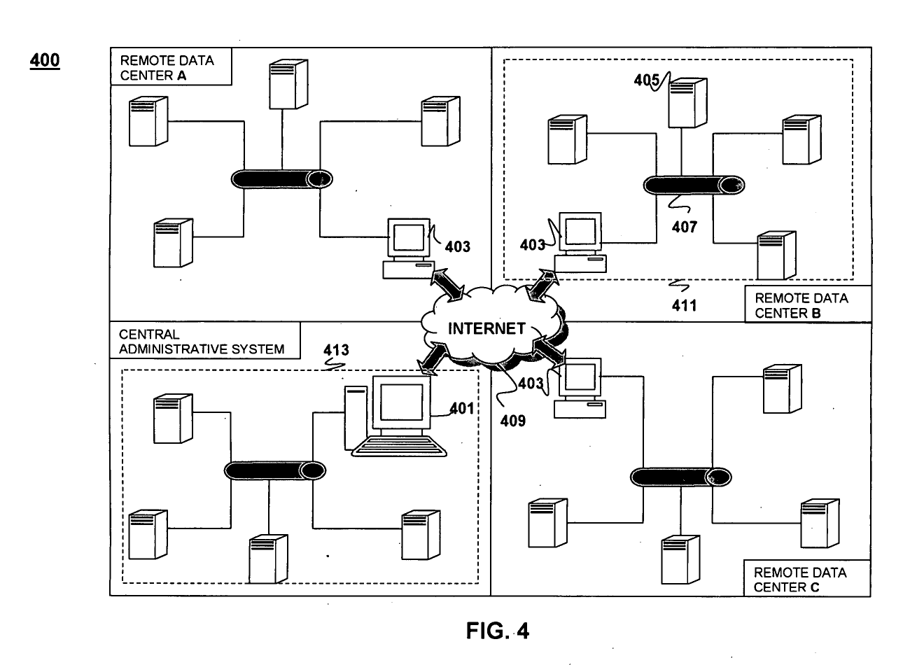

According to a third embodiment illustrated in FIG. 4, secure data center administration may be handled through the use of control hosts 403. This solution addresses the issue of how to securely administer remote data centers 411 without being granted access to a given data center's network. According to the third embodiment, a database system 400 may be configured to provide for the delegation of responsibility for the network. This may be achieved by inserting a control host 403 between a central administrative system 413 and the remote data center 411. Each control host 403 resides in the remote data center 411, and is controlled by that data center's 411 respective administrator. The central administrative system 413 may be implemented by one or more electronic processing devices, such as a general purpose computer. A central application 401 running on the central administrative system 413 only needs administrative access to the control hosts 403 in order to access the networks administered by the control hosts. Each control host 403 has access to all of the remote hosts 405 for the corresponding remote data center 411.

In general, the term “host”, as used herein refers to an electronic processing device that is capable of performing electronic computations or otherwise manipulating and/or storing electronic data and communicating with one or more other such electronic processing devices over a network. By way of example, but not by way of limitation, a host may be a general purpose computer that becomes a special purpose computer when programmed with suitable instructions.

When a new remote data center 411 is added, the owner of that data center 411 only needs to provide a single control host 403 that allows access into the data center's network. That control host 403 may grant secure access to the central application 401, e.g., through use of suitable security measures, such as trusted encryption keys. By way of example, a suitable security measure might be SSH, Kerberos, or the like.

Similarly, each host 405 in the data center 411 may use the same type of security measures, e.g., trusted encryption keys, to grant access to the control host 403. It is not possible for the central application 411 to access the remote host 405 directly, thus ensuring security.

The central application 401 may maintain a mapping of which hosts 405 are in which data centers 411, and what the control host 403 is for that data center 411. The central application 401 then proxy its commands to the remote hosts 405 using the control host 403.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A” or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A method for change management in a relational database, comprising
indexing changes by way of revisions stored in the relational database;
copying all data in the database to a new revision when a change is made to one or more items of data in the relational database;
committing the new revision as a single unit wherein all changes are stored together under a single revision; and
publishing to users of the database an indication of a particular revision that should be used.

2. The method of claim 1, wherein publishing the indication comprises marking the particular a revision as “active”.

3. The method of claim 1 wherein the relational database is a software database.

4. In a database management system, a method for change management, comprising:
a) recording information representing a state of data in a database at particular instant of time;
b) saving the information representing the state as a revision on a central server;
c) associating the revision with the state of the database at the particular instant in time; and
d) publishing information identifying the revision as the active revision to one or more local servers.

5. The method of claim 4, further comprising reverting to a previously saved revision by publishing information identifying the previously saved revision as the active revision to one or more local servers.

6. The method of claim 4 wherein the database is a relational database.

7. The method of claim 4 wherein the database is a software database.

8. In a local server coupled to a central server for a database, a method for handling changes to the database, comprising:
a) receiving information identifying an active revision of data in the database at the local server; and
b) requesting data from the central server with the local server, wherein the data are associated with the active revision.

9. The method of claim 8 wherein the database is a software database.

10. A database management system for a central server coupled to one or more local servers, comprising:
a computer processor coupled to the central server;
a memory coupled to the central server, the memory having embodied therein a database; and
a set of computer instructions executable by the processor, the instructions being configured to implement a method for change management, the instructions comprising:
a) an instruction that, when executed by the processor, causes the processor to record information representing a state of data in the database at particular instant of time;
b) an instruction that, when executed by the processor, causes the processor to save the information representing the state of the data in the database at particular instant of time as a revision in the memory;
c) an instruction that, when executed by the processor, causes the processor to associate the revision with the state of the database at the particular instant in time; and
d) an instruction that, when executed by the processor, causes the processor to publish information identifying the revision as an active revision to the one or more local servers.

11. The system of claim 10 wherein the computer instructions further comprise:
e) an instruction that, when executed by the processor, causes the processor to publish information identifying a previously saved revision as the active revision to one or more local servers.

12. The system of claim 10 wherein the database is a software database.

13. A local server coupled to a central server for a database, comprising:
a computer processor coupled to the local server; and
a set of computer instructions executable by the processor, the instructions being configured to implement a method for handling changes to the database, the instructions comprising:
a) an instruction that, when executed by the processor, causes the processor to receive information identifying an active revision of data in the database at the local server; and
b) an instruction that, when executed by the processor, causes the processor to request one or more files from the central server with the local server, wherein the one or more files are associated with the active revision.

14. The system of claim 13 wherein the database is a software database.

15. A method for configuration substitution, comprising:
a) defining a logical configuration using a specific software configuration of a configuration in a network, wherein the definition includes defining relationships between one or more components of the configuration or defining one or more setting values of the configuration; and
b) substituting this logical configuration to define one or more setting values and one or more component relationships for one or more other specific configurations that are in the network.

16. The method of claim 15, wherein a) includes expressing connections between components of the configuration.

17. The method of claim 15, wherein b) includes concatenating together one or more setting values from one or more specific configurations.

18. The method of claim 15, wherein b) includes substituting one or more default setting values in a specific software configuration

19. A method for secure data center administration comprising:
a) controlling one or more remote hosts of a remote data center with a control host that resides within a remote data center network having one or more remote hosts;
b) allowing a central administrative system access to the control host, without allowing the central administrative system direct access to the one or more remote hosts of the remote data center; and
c) relaying commands sent from the central administrative system to the one or more remote hosts of the remote data center through the control host.

20. The method of claim 19, wherein b) includes allowing access to one or more remote hosts of the remote data center through the use of trusted encryption keys.

21. The method of claim 19, wherein c) includes allowing access by the control host to the central administrative system through the use of trusted encryption key.

22. A system for secure data center administration comprising:
a control host that resides within a network of a remote data center having one or more remote hosts, wherein the control host is configured to control one or more of the remote hosts, wherein the control host is configured to allow a central administrative system access to the control host without allowing the central administrative system direct access to the one or more remote hosts, and wherein the control host is configured to relay commands sent from the central administrative system to the one or more remote hosts.

23. The system of claim 22 wherein the control host is configured to access the central administrative system through the use of trusted encryption keys.

24. The system of claim 22 wherein each of the control host is configured to allow the central administrative system to access the one or more remote hosts through use of trusted encryption keys.

25. The system of claim 22, further comprising the remote data center having the network with the one or more remote hosts.

26. The system of claim 22, further comprising, the central administrative system.
